(19) United States
(12) Patent Application Publication
(10) Pub. No.: US 2007/0192393 A1
(43) Pub. Date: Aug. 16, 2007

(54) Method and system for hardware and software shareable DCT/IDCT control interface

(76) Inventors: Taiyi Cheng, San Jose, CA (US); Mark D. Hahm, Hartland, WI (US); Li Fung Chang, Holmdel, NJ (US)

Correspondence Address: MCANDREWS HELD & MALLOY, LTD, 500 WEST MADISON STREET, SUITE 3400, CHICAGO, IL, 60661, US

(21) Appl. No.: 11/353,367

(22) Filed: Feb. 14, 2006

(51) Int. Cl. G06F 17/14

(52) U.S. Cl. 708/402

(57) ABSTRACT

Certain aspects of a method and system for hardware and software shareable DCT/IDCT control interface are provided. A single DCT/IDCT interface may be utilized to provide hardware or software control of a DCT/IDCT module. During hardware control the DCT/IDCT module may be utilized for JPEG compression, for example. During software control a CPU may utilize the DCT/IDCT module for audio, software, and/or video applications, for example. The interface may enable selecting a quantization table for use by the DCT/IDCT module. The interface may also enable selecting encoding or decoding operations to be performed by the DCT/IDCT module. The interface may also enable toggling between a first and a second portion of a data buffer utilized by the DCT/IDCT module. Moreover, the interface may enable starting processing of a data block by the DCT/IDCT module and indicating when the DCT/IDCT module has completed processing the data block.

### FIELD OF THE INVENTION

Certain embodiments of the invention relate to controlling the processing of signals. More specifically, certain embodiments of the invention relate to a method and system for a hardware and software shareable DCT/IDCT control interface.

### BACKGROUND OF THE INVENTION

The growing computational complexity and data rate requirements of new multimedia applications demand that signal processing systems provide efficient and flexible compression and decompression routines. With a plurality of image and video coding and decoding standards available, the signal processing system may have to be flexible enough to implement at least one of these standards. Examples of image and video coding and decoding standards that may be used in various user devices comprise Joint Photographic Experts Group (JPEG), Moving Picture Experts Group (MPEG), and H.263 standard published by the International Telecommunications Union (ITU).

The JPEG standard utilizes a lossy compression technique for compressing still images based on the discrete cosine transform (DCT) and the inverse cosine transform (IDCT) for coding and decoding operations respectively. The JPEG standard is rarely used in video, but it forms the basis for motion-JPEG (M-JPEG) which may be used in desktop video editing and digital video (DV) compression, a compression and data packing scheme used in consumer digital video cassette recorders and their professional derivatives. In the JPEG standard an 8×8 array of sample data known as a video data block may be used for processing, where the sample data may correspond to luminance (Y) or chrominance (Cr and Cb) information of the still image or video signal. Four 8×8 blocks of luminance, an 8×8 block of Cr, and an 8×8 block of Cb data is known in JPEG terminology as a minimum coded unit (MCU) and it corresponds to a macroblock in DV or MPEG terminology.

The MPEG standard is also based on the DCT/IDCT pair and may provide intraframe or interframe compression. In interframe compression, there may be an anchor or self-contained image in a video field that provides a base value and succeeding images may be coded based on their differences to the anchor. In intraframe compression, each image in a video field is compressed or coded independently from any other image in a video sequence. The MPEG standard specifies what may constitute a legal bitstream, that is, it provides guidelines as to what is a conformant encoder and decoder but does not standardize how an encoder or a decoder may accomplish the compression or decompression operations respectively.

The H.263 standard may support video coding and decoding for video-conferencing and video-telephony application. Video-conferencing and video-telephony may have a wide range of wireless and wireline applications, for example, desktop and room based conferencing, video over the Internet and over telephone lines, surveillance and monitoring, telemedicine, and computer-based training and education. Like MPEG, the H.263 standard specifies the requirements for a video encoder and decoder but does not describe the encoder and decoder themselves. Instead, the H.263 standard specifies the format and content of the encoded bitstream. Also like MPEG and JPEG, the H.263 standard is also based on the DCT/IDCT pair for coding and decoding operations.

The encoding and decoding operations specified by, for example, the JPEG, MPEG, and H.263 standards may be implemented in software to be run on signal processing integrated circuits (IC) with embedded processors such as systems-on-a-chip (SOC). These SOC image and video (IV) solutions need to be highly effective in terms of performance, cost, power and flexibility. However, processor-based SOC devices where these operations may run efficiently are proving difficult to implement. This difficulty arises because system software and/or other data processing applications executed on the embedded processor demand a large portion of the computing resources available on the SOC, limiting the ability of the coding and decoding operations to be performed as rapidly as may be required for a particular data transmission rate.

The use of embedded digital signal processors (DSP) in an SOC design may provide the increased computational speed needed to execute coding and decoding software. However, this approach may prove to be costly because an embedded DSP is a complex hardware resource that may require a large portion of the area available in an SOC design. Moreover, additional processing hardware, for example an embedded processor or a microcontroller, may still be required to provide system level control and/or other functions for the signal processing IC.

A solution that requires a relatively small area in an SOC and that is computationally efficient and operationally flexible for performing coding and decoding operations for image and video applications remains an important challenge in the design of signal processing ICs for multimedia applications.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for a hardware and software shareable DCT/IDCT control interface, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is block diagram illustrating exemplary encoding process, in connection with an embodiment of the invention.

FIG. 2 is block diagram illustrating exemplary decoding process, in connection with an embodiment of the invention.

FIG. 3 is a block diagram of an exemplary JPEG encoding accelerator, in connection with an embodiment of the invention.

FIG. 4 is a block diagram of an exemplary JPEG decoding accelerator, in connection with an embodiment of the invention.

FIG. 5A is diagram illustrating exemplary steps in an encoding process, in connection with an embodiment of the invention.

FIG. 5B is diagram illustrating exemplary steps in a decoding process, in connection with an embodiment of the invention.

FIG. 6 is a block diagram of a system for pipelined processing in an integrated embedded image and video accelerator in connection with an embodiment of the invention.

FIG. 7A is a block diagram illustrating an exemplary hardware/software shareable (HW/SW) interface for controlling a DCT/IDCT module, in accordance with an embodiment of the invention.

FIG. 7B is a flow diagram illustrating exemplary steps in the operation of the hardware/software shareable interface, in accordance with an embodiment of the invention.

FIG. 8 is a block diagram of exemplary processing elements in a DCT/IDCT module, in accordance with an embodiment of the invention.

FIGS. 9A-9C illustrate exemplary DCT processing network configurations for JPEG, MPEG, and H.263 video formats, in connection with an embodiment of the invention.

FIG. 10 is a flow chart illustrating exemplary steps for the encoding of video signals utilizing the DCT/IDCT module in a DCT processing network configuration, in accordance with an embodiment of the invention.

FIGS. 11A-11C illustrate exemplary IDCT processing network configurations for JPEG, MPEG, and H.263 video formats, in connection with an embodiment of the invention.

FIG. 12 is a flow chart illustrating exemplary steps for the decoding of video signals utilizing the DCT/IDCT module in a IDCT processing network configuration, in accordance with an embodiment of the invention.

### DETAILED DESCRIPTION OF THE INVENTION

Certain embodiments of the invention may be found in a method and system for hardware and software shareable DCT/IDCT control interface. A single DCT/IDCT interface may be utilized to provide hardware or software control of a DCT/IDCT module. During hardware control the DCT/IDCT module may be utilized for JPEG compression, for example. During software control a CPU may utilize the DCT/IDCT module for audio, software, and/or video applications, for example. The interface may enable selecting a quantization table for use by the DCT/IDCT module. The interface may also enable selecting encoding or decoding operations to be performed by the DCT/IDCT module. The interface may also enable toggling between a first and a second portion of a data buffer utilized by the DCT/IDCT module. Moreover, the interface may enable starting processing of a data block by the DCT/IDCT module and indicating when the DCT/IDCT module has completed processing the data block.

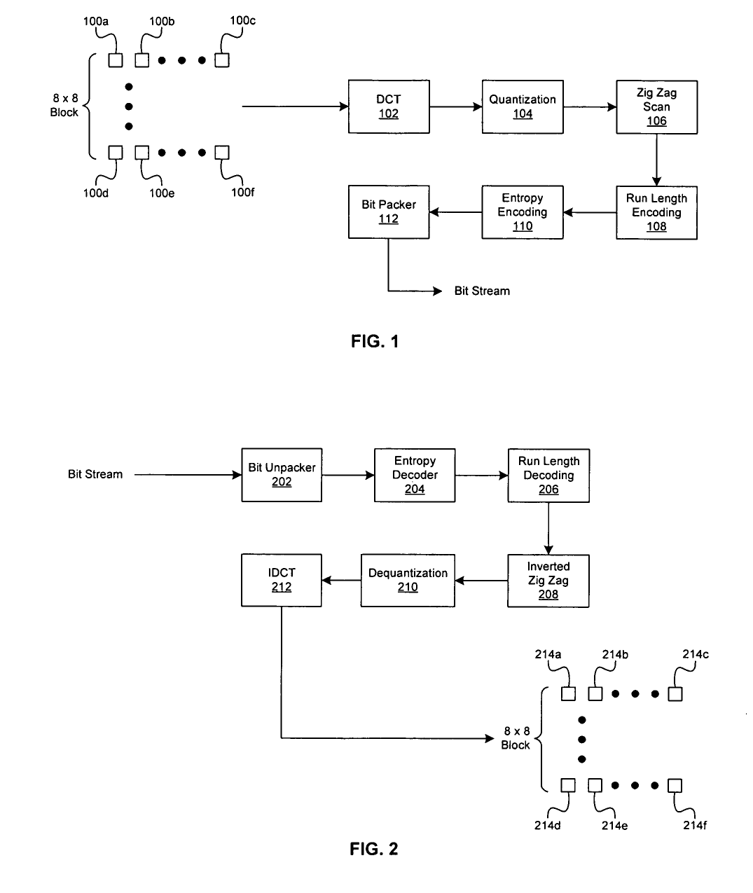

FIG. 1 is block diagram illustrating exemplary encoding process, in connection with an embodiment of the invention. Referring to FIG. 1 there is shown an 8×8 pixel block 100, a discrete cosine transform (DCT) block 102, a quantization block 104, a zig zag scan block 106, a run length encoding (RLC) block 108, an entropy encoding block 110, and a bit packer block 112.

The 8×8 pixel block 100 may comprise pixels arranged in rows and columns in which each of the 8 rows may comprise 8 pixels. The pixels 100a, 100b . . . 100c may represent pixels in a first row of the 8×8 pixel block 100. The pixels 100d, 100e . . . 100f may represent pixels in a subsequent row of the 8×8 pixel block 100.

Each pixel in the 8×8 pixel block 100 may comprise luminance (Y), chrominance U (U) information, and/or chrominance V (V) information. The Y, U, and/or V information may correspond to a pixel in an image frame, for example. The Y, U, and/or V information associated with a pixel may be referred to as a YUV representation. The YUV representation for a pixel may be derived from a corresponding representation of the pixel as comprising red (R) information, green (G) information, and/or blue (B) information.

The DCT block 102 may comprise suitable logic, circuitry and/or code that may enable discrete cosine transformation of the 8×8 pixel block 100. The DCT block 102 may enable computation of transformed values corresponding to values, for example YUV values, associated with the pixels 100a, 100b . . . 100c, 100d, and 100e . . . 100f, contained within the 8×8 pixel block 100. The pixels in the 8×8 pixel block 100 may comprise values associated with intensities associated with YUV information. The transformed values computed by the DCT block 102 may comprise a frequency representation of values in the YUV representation. For example, the transformed values may indicate high frequency components and low frequency components associated with the 8×8 pixel block 100. High frequency components may represent areas in the 8×8 pixel block 100 where there may be a rapid change in intensity values among pixels. The resulting 8×8 block of transformed values may comprise 8 rows with each row comprising a plurality of 8 transformed values, for example.

The quantization block 104 may comprise suitable logic, circuitry and/or code that may enable quantization of the transformed values computed by the DCT block 102. The quantization may comprise deriving a binary representation of the corresponding transformed value computed by the DCT block 102. The corresponding transformed value may represent a numerical value. The binary value associated with the binary representation may not be equal to the corresponding transformed value computed by the DCT block 102. A difference between the binary value and the corresponding transformed value may be referred to as quantization error. The quantization block 104 may utilize a number of bits in a binary representation based on a numerical value of the corresponding transformed value.

The zig zag scan block 106 may comprise suitable logic, circuitry and/or code that may enable selection of quantized values from a block of quantized values. For example, the zig zag scan block 106 may implement a raster scan of an 8×8 block of quantized values. The zig zag scan block 106 may convert the representation of the quantized values from a block of 64 individual binary values, to a single concatenated string of binary values, for example. In the concatenated string of binary values, a binary value associated with the second quantized value in the 8×8 block of quantized values may be appended to a binary value associated with the first quantized value to form a single binary number, for example.

The run length encoding (RLC) block 108 may comprise suitable logic, circuitry and/or code that may be utilized to reduce redundancy in the concatenated string of binary values generated by the zig zag scan block 106. If the concatenated string of binary values comprises a contiguous substring of consecutive binary ‘0’ values, for example, the RLC block 108 may replace the contiguous substring with an alternative representation that indicates the number of consecutive binary ‘0’ values that were contained in the original concatenated string of binary values. The alternative representation may comprise fewer binary bits than the contiguous substring. The RLC block 108 may generate a RLC bit stream.

The entropy encoding block 110 may comprise suitable logic, circuitry and/or code that may enable entropy encoding of the RLC bit stream from the RLC block 108. In one embodiment of the invention, the entropy encoding block 110 may comprise a Huffman encoder. In this regard, the entropy encoder block 110 may be referred to as a Huffman encoding block 110. Notwithstanding, the invention is not limited in this regard, and other types of entropy encoders may be utilized. In this regard, various exemplary embodiments of the invention may utilize Huffman encoding, arithmetic encoding, unary encoding, Elias gamma encoding, Fibonacci encoding, Golomb encoding, Rice encoding and/or other encoding scheme.

The RLC bit stream may comprise groups of contiguous bits, for example, 8 bits. Each group of 8 bits may correspond to a symbol. Entropy encoding may enable data compression by representing the symbol with an entropy encoded representation that comprises fewer bits. Each of the plurality of symbols may comprise an equal number of bits. Each of the plurality of symbols from the RLC bit stream may be entropy encoded to form a plurality of symbols. Each of the entropy encoded symbols may comprise a varying numbers of bits. The entropy encoded version of the RLC bit stream may comprise fewer bits than may be in the original RLC bit stream.

The bit packer block 112 may comprise suitable logic, circuitry and/or code that may enable insertion of stuff bits into the entropy encoded bit stream generated by the entropy encoding block 110. The entropy encoded bit stream may comprise a plurality of bits. That number of bits may not be an integer multiple of 8, for example. Such an entropy encoded bit stream may not be aligned to an 8 bit byte, or to a data word wherein the length of the data word is an integer multiple of 8. The bit packer block 112 may insert stuff bits into the entropy encoded bit stream such that the total of the number of bits in the entropy encoded bit stream and the number of stuff bits may be an integer multiple of 8, or an integer multiple of the number of bits in a data word. The bit stuffed version of the entropy encoded bit stream may be referred to as being byte aligned, or word aligned. The binary value of each stuff bit may be a determined value, for example, a binary ‘0’ value. The resulting bit stream may be stored in memory, for example.

FIG. 2 is block diagram illustrating exemplary decoding process, in connection with an embodiment of the invention. Referring to FIG. 1 there is shown a bit unpacker block 202, an entropy decoding block 204, a run length decoding (RLDC) block 206, an inverted zig zag scan block 208, a de-quantization block 210, an inverse discrete cosine transform (IDCT) block 212, and an 8×8 pixel block 214.

The bit unpacker block 202 may comprise suitable logic, circuitry and/or code that may enable removal of stuffed bits from a byte-aligned bit stream. The stuff bits may have previously been inserted into the bit stream.

The entropy decoder block 204 may comprise suitable logic, circuitry and/or code that may enable entropy decoding of the bit stream received from the bit unpacker block 202. Entropy decoding may comprise a data expansion method by which a previously entropy encoded symbol is decoded. In one embodiment of the invention, the entropy encoding block 204 may comprise a Huffman decoder. In this regard, the entropy decoder block 204 may be referred to as a Huffman encoding block 204. Notwithstanding, the invention is not limited in this regard, and other types of entropy decoders may be utilized. In this regard, various exemplary embodiments of the invention may utilize Huffman decoding, arithmetic decoding, unary decoding, Elias gamma decoding, Fibonacci decoding, Golomb decoding, Rice decoding and/or other types encoding schemes.

The entropy decoder block 204 may receive a plurality of encoded symbols contained in a received bit stream. Each of the entropy encoded symbols may comprise a variable number of bits. The entropy decoding block 204 may decode each of the plurality of entropy encoded symbols to generate a corresponding plurality of entropy decoded symbols. Each of the plurality of entropy decoded symbols may comprise an equal number of bits.

The run length decoding (RLDC) block 206 may comprise suitable logic, circuitry and/or code that may enable processing of a bit stream received from the entropy decoding block 204 comprising entropy decoded symbols. The RLDC block 206 may utilize RLC information contained in the received bit stream to insert bits into the bit stream. The inserted bits may comprise a contiguous substring of consecutive binary ‘0’ values, for example. The RLDC block 206 may generate an RLDC bit stream in which RLC information in the received bit stream may be substituted for corresponding inserted bits.

The inverted zig zag scan block 208 comprise suitable logic, circuitry and/or code that may enable processing of an RLDC bit stream received from the RLDC block 206. The inverted zig zag scan block 208 may enable conversion a single received bit stream into a plurality of binary values. For example, the RLDC may generate 64 binary values, for example. The plurality of binary values may be arranged in a block, for example, an 8×8 block. The first 8 binary values may be associated with a first row in the 8×8 block, the second 8 binary values may be associated with a second row, and the last 8 binary values may be associated with a last row, for example.

The de-quantization block 210 may comprise suitable logic, circuitry and/or code that may enable processing of a received block of values from the inverted zig zag scan block 208. The de-quantization block 210 may enable inverse quantization of the received block of values. Inverse quantization may comprise determining a numerical value based on a binary value. The numerical value may comprise a base 10 representation of the corresponding binary value. The de-quantization block 210 may also enable inverse quantization for each of the binary values contained in a received block of values. The de-quantization block may generate a corresponding block of numerical values.

The IDCT block 212 may comprise suitable logic, circuitry and/or code that may enable processing of a received block of numerical values from the de-quantization block 210. The received block of numerical values may comprise a frequency representation of YUV information associated with the 8×8 block 214. The IDCT block 212 may perform an inverse discrete cosine transform on the received block of numerical values. The inverse discrete cosine transformed block of numerical values may comprise a corresponding block of YUV information associated with the 8×8 block 214. The YUV information resulting from the inverse discrete cosine transformation may be stored in memory.

The 8×8 block 214 may comprise pixels arranged in rows and columns where each row may comprise 8 pixels with 8 rows in the 8×8 block. The pixels 214a, 214b . . . 214c may represent pixels in a first row of the 8×8 block. The pixels 214d, 214e . . . 214f may represent pixels in a subsequent row of the 8×8 block. Each of the pixels in the 8×8 block 214 may comprise YUV information, for example. The YUV information may be retrieved from memory and converted to an RGB representation during post processing.

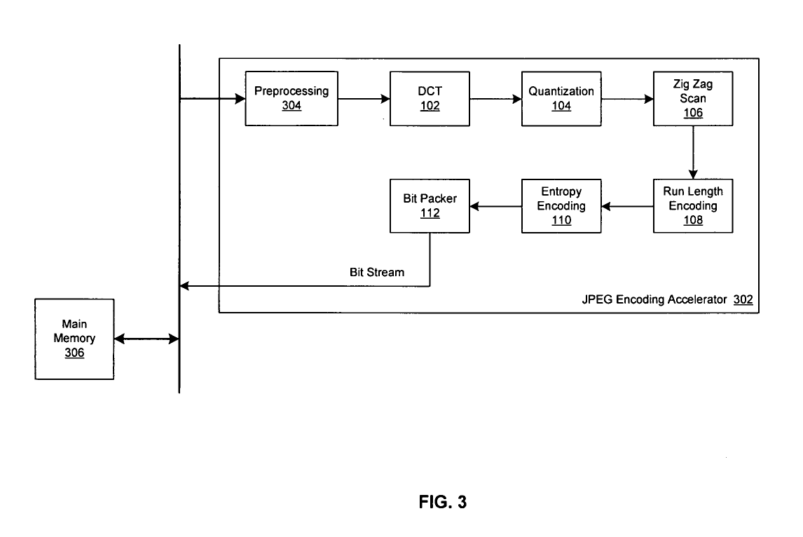

FIG. 3 is a block diagram of an exemplary JPEG encoding accelerator in connection with an embodiment of the invention. Referring to FIG. 3, there is shown a JPEG encoding accelerator 302, and a main memory 306. The JPEG encoding accelerator 302 may comprise a preprocessing block 304, a DCT block 102, a quantization block 104, a zig zag scan block 106, a RLC block 108, an entropy encoding block 110, and a bit packer block 112.

The preprocessing block 304 may comprise suitable logic, circuitry and/or code that may enable preprocessing of data. In an exemplary embodiment of the invention, the preprocessing block 304 may convert an RGB data representation to a YUV data representation.

The main memory 306 may comprise suitable logic, circuitry, and/or code that may enable storing and/or retrieving of data, and/or other information that may be utilized by the JPEG encoding accelerator 302 during operations. Data stored in the main memory 306 may be byte-aligned, or word-aligned. The main memory 306 may enable storage of image data from a camera in an RGB representation, for example. The main memory 306 may enable storage of image data in a YUV representation, for example. The main memory 306 may store results of computations by the preprocessing block 304, DCT block 102, quantization block 104, zig zag scan block 106, RLC block 108, entropy encoding block 110, and/or bit packer block 112. The main memory 306 may enable retrieval of data by the preprocessing block 304, DCT block 102, quantization block 104, zig zag scan block 106, RLC block 108, entropy encoding block 110, and/or bit packer block 112.

In operation, an RGB representation of data may be retrieved from the main memory 306 by the preprocessing block 304. The preprocessing block 304 may convert the RGB representation of the data to a YUV representation of the data.

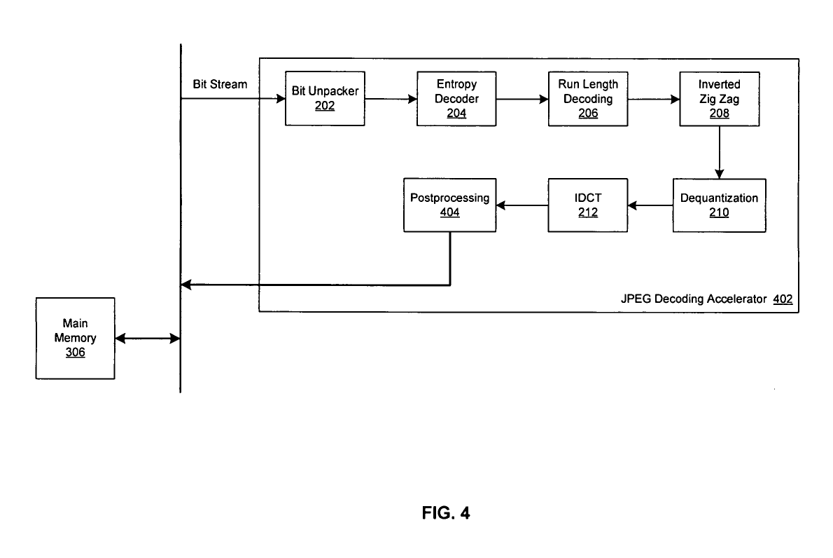

FIG. 4 is a block diagram of an exemplary JPEG decoding accelerator in connection with an embodiment of the invention. Referring to FIG. 4, there is shown a JPEG decoding accelerator 402, and a main memory 306. The JPEG decoding accelerator 402 may comprise a bit unpacker block 202, a entropy decoding block 204, an RLDC block 206, an inverted zig zag scan block 208, a de-quantization block 210, an IDCT block 212, and a post processing block 404.

Each of the bit unpacker block 202, entropy decoding block 204, RLDC block 206, inverted zig zag scan block 208, de-quantization block 210, IDCT block 212 are substantially as described with regards to at least FIG. 2. The entropy decoding block 204 may comprise a Huffman decoder. The post processing block 404 may comprise suitable logic circuitry and/or code that may enable post processing of received data. In an exemplary embodiment of the invention, the post processing block 404 may convert a YUV data representation to an RGB data representation. The transformed block of numerical values may comprise YUV information. The post-processing block 404 may be utilized to perform post processing of data. For example, the post-processing block 404 may convert YUV formatted data to RGB formatted data.

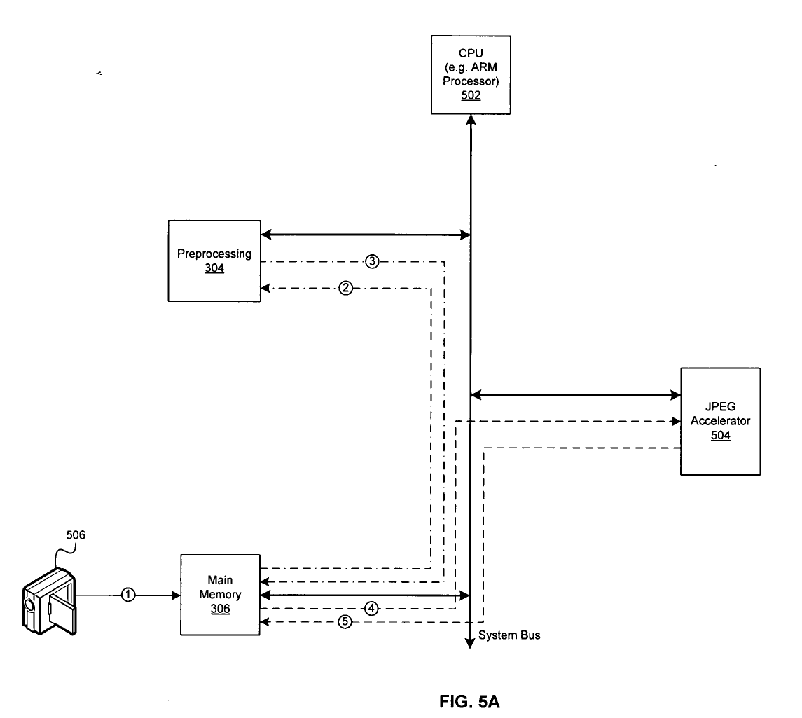

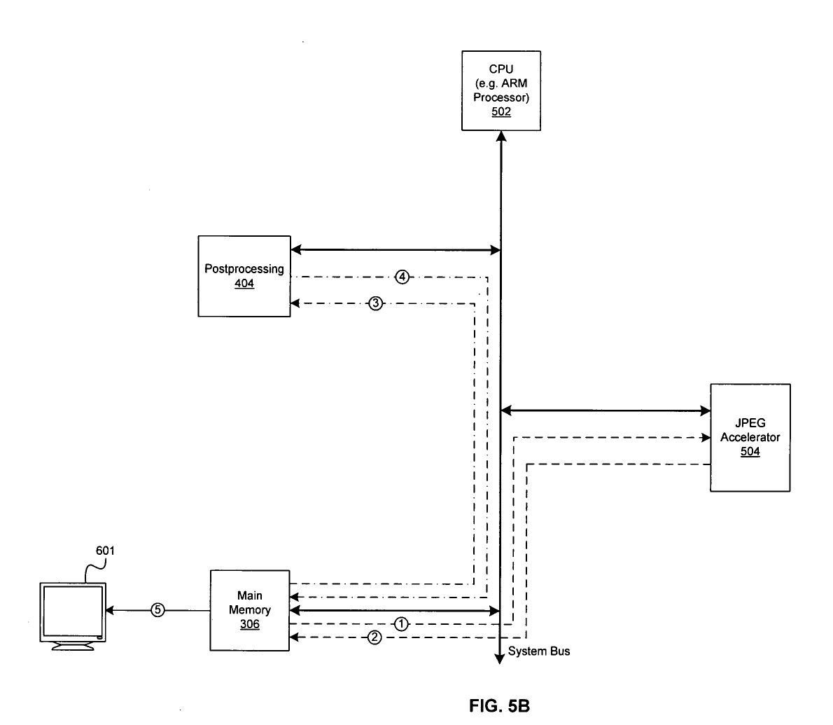

FIG. 5A is a diagram illustrating exemplary steps in an encoding process in connection with an embodiment of the invention. Referring to FIG. 5A, there is shown a central processing unit (CPU) 502, a JPEG accelerator 504, a preprocessing block 304, a main memory 306, and a camera 506. The CPU 502, JPEG accelerator 504, preprocessing block 304, and/or main memory 306 may communicate via a system bus, for example.

The CPU 502 may comprise suitable logic, circuitry, and/or code that may enable execution of software, processing of data, and/or control of system operations. The CPU 502 may generate control signals and/or configuration data that may enable peripheral hardware devices to perform system operations in hardware. The CPU 502 may also receive control signals and/or data from peripheral hardware devices. Based on the received control signals and/or data, the CPU 502 may execute code, process the received data, and/or generate subsequent control signals.

In an embodiment of the invention, the CPU 502 may be implemented in an integrated circuit (IC) device. In another embodiment of the invention, the CPU 502 may be implemented as a processor core that is a component within an IC device, for example, as in a system on a chip (SoC) device. A SoC device may comprise the CPU 502, the JPEG accelerator 504, and/or the preprocessing block 304, for example.

The JPEG accelerator 504 may comprise suitable logic, circuitry and/or code that may enable execution of the functions and operation that may be handled by the JPEG encoding accelerator 302, and/or the JPEG decoding accelerator 402.

The camera 506 may comprise suitable circuitry, logic, and/or code that may enable capturing of a visual image and generation of image data. The camera 506 may also comprise an interface that enables storing of image data, as an RGB representation, for example, in the main memory 306.

Referring to FIG. 5A in operation, the camera 506, may capture an image and store the captured image in RGB format in main memory 306, as indicated by the reference 1 in FIG. 5A. The preprocessing block 304 may retrieve the RGB formatted data from the main memory 306, as indicated by reference 2 in FIG. 5A. The preprocessing block 304 may convert the RGB formatted data to YUV formatted data. The preprocessing block may store the YUV formatted data as indicated by reference 3 in FIG. 5A. The JPEG accelerator 504 may retrieve the YUV formatted data from the main memory 306, as indicated by the reference 4 in FIG. 5A. The JPEG accelerator 504 may encode the YUV data based on DCT and/or entropy encoding. The JPEG accelerator 504 may store the encoded YUV data in the main memory 306, as indicated by reference 5 in FIG. 5A.

FIG. 5B is a diagram illustrating exemplary steps in a decoding process in connection with an embodiment of the invention. Referring to FIG. 5B, there is shown a central processing unit (CPU) 502, a JPEG accelerator 504, a post processing block 404, a main memory 306, and a display 601. The CPU 502, JPEG accelerator 504, preprocessing block 304, and/or main memory 306 may communicate via a system bus, for example. This central processing unit (CPU) 502, JPEG accelerator 504, post-processing block 404, and/or main memory 306 are substantially as describe with respect to FIG. 1-4.

The display 601 may comprise suitable circuitry, logic, and/or code that may be utilized to display a visual image based on image data. The displayed visual image may be represented as a plurality of pixels arranged in rows and columns. The visual image may be displayed based on a raster scan. Image data, associated with each pixel in an image frame may be displayed by the display 601, which may be, for example, a cathode ray tube (CRT), Plasma, liquid crystal diode (LCD), or other type of display. In one embodiment of the invention, the display 601 may comprise an interface that allows the image data to be retrieved from the main memory 306. For example, the display 601 may comprise and RGB interface that allows RGB formatted data to be retrieved from the main memory 306.

Referring to FIG. 5B in operation, the JPEG accelerator 504 may retrieve encoded data from the main memory 306, as indicated by reference 1 in FIG. 5B. The JPEG accelerator 504 may decode the encoded data based on IDCT and/or entropy decoding. The JPEG accelerator 504 may store the decoded data in the main memory 306, as indicated by reference 2 in FIG. 5B. The post-processing block 404 may retrieve the decoded data from the main memory 306, as indicated by reference 3 in FIG. 5B. The post-processing block may convert a YUV data representation, contained in the decoded data, to an RGB data representation. The post-processing block 404 may store the RGB data representation in the main memory 306, as represented by the number 4 in FIG. 5B. The display 601 may retrieve the RGB data representation of the decoded data from the main memory 306, as represented by the number 5 in FIG. 5B. The retrieved RGB formatted data may be displayed on the video monitor 601.

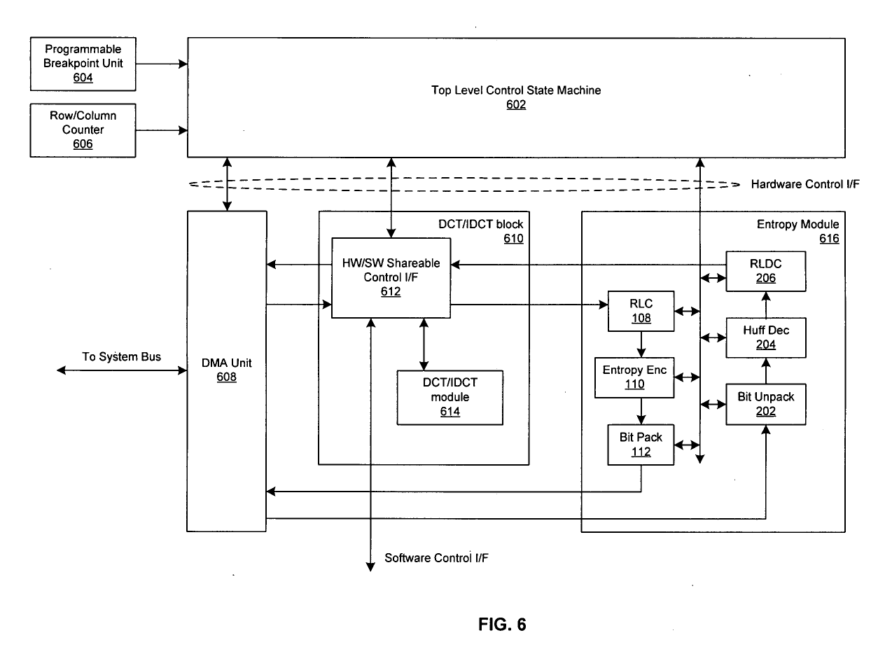

FIG. 6 is a block diagram of a system for pipelined processing in an integrated embedded image and video accelerator in connection with an embodiment of the invention. The JPEG accelerator 504 may be an exemplary embodiment of an integrated embedded image and video accelerator. Referring to FIG. 6, there is shown a top-level control state machine 602, a programmable breakpoint unit 604, a row and column (row/column) counter block 606, a direct memory access (DMA) unit 608, a DCT and IDCT (DCT/IDCT) block 610, and an entropy module 616. The DCT/IDCT block 610 may comprise a hardware and software (HW/SW) sharable control interface (I/F) 612, and a DCT/IDCT module 614. The entropy coding module 616 may comprise an RLC block 108, an entropy encoding block 110, a bit packing block 112, an RLDC block 206, an entropy decoding block 204, and a bit unpacking block 202.

The top-level control state machine 602 may comprise suitable logic, circuitry, and/or code that may enable controlling of the operation of the DMA unit 608, the DCT/IDCT block 610, and/or the entropy coding module 616 via a hardware control I/F. The top-level control state machine 602 may also receive status information from the DMA unit 608, the DCT/IDCT block 610, and/or the entropy coding module 616 via the hardware control I/F. The top-level control state machine 602 may receive control signals from the programmable breakpoint unit 604 and/or the row/column counter block 606. The top-level control state machine 602 may receive control information from the CPU 502 via a software control I/F. The top-level control state machine 602 may also communicate status information to the CPU 502 via the software control I/F.

For the encoding operation, the CPU 502 may send control signals to the top-level control state machine 602 that enables the JPEG accelerator 504 to encode an image stored in the main memory 306. The top-level control state machine 602 may determine when the JPEG accelerator 504 is to receive a current 8×8 pixel block 100 from the main memory 306. The top-level control state machine 602 may send control signals that enable the DMA unit 608 to retrieve the current 8×8 pixel block 100 from the main memory 306. The received current 8×8 pixel block 100 may be transferred to the DCT/IDCT block 610. The top-level control state machine 602 may send control signals that may enable the DCT/IDCT block 610 to transform and/or quantize the received current 8×8 pixel block 100. The top-level control state machine 602 may receive status information from the DCT/IDCT block 610 that indicates completion of transformation and quantization of the received 8×8 pixel block 100 and generation of a corresponding transformed current 8×8 block.

The top-level control state machine 602 may send control signals that may enable the entropy coding module 616 to perform RLC, entropy coding and/or bit packing on the transformed current 8×8 block. The top-level control state machine 602 may send control signals that enable the DCT/IDCT block 610 to transform and/or quantize a subsequent 8×8 pixel block 100 received from the main memory 306. The DCT/IDCT module may perform transformation and/or quantization operations on the subsequent 8×8 pixel block 100 while the entropy coding module 616 is performing RLC, entropy coding and/or bit packing on the transformed current 8×8 block. The top-level control state machine 602 may receive status information from the entropy coding module 616 that indicates completion of RLC, entropy encoding and/or bit packing on the transformed current 8×8 block and generation of a corresponding encoded bit stream. The top-level control state machine 602 may send control signals that enable the DMA unit 608 to store the encoded bit stream in the main memory 306. The top-level control state machine 602 may subsequently send status information to the CPU 502 to indicate that at least a portion of the image stored in the main memory 306 has been encoded.

For the decoding operation, the CPU 502 may send control signals to the top-level control state machine 602 that enable the JPEG accelerator 504 to decode encoded data stored in the main memory 306. The top-level control state machine 602 may determine when the JPEG accelerator 504 is to receive a current encoded bit stream from main memory 306. The top-level control state machine 602 may send control signals that enable the DMA unit 608 to retrieve the current encoded bit stream from the main memory 306. The current encoded bit stream may be transferred to the entropy coding module 616.

The top-level control state machine 602 may send control signals that may enable the entropy coding module 616 to perform bit unpacking, entropy decoding and/or RLDC on the current encoded bit stream. The top-level control state machine 602 may receive status information from the entropy coding module 616 that indicates completion of bit unpacking, entropy decoding, and/or RLDC on the current encoded bit stream and generation of a corresponding decoded current encoded bit stream.

The top-level control state machine 602 may send control signals that may enable the DCT/IDCT block 610 to perform IDCT and/or inverse quantization on the decoded current encoded bit stream. The top-level control state machine 602 may receive status information from the DCT/IDCT block 610 that indicates completion of IDCT and/or inverse quantization of the decoded current encoded bit stream and generation of a decoded 8×8 pixel block 214. The top-level control state machine 602 may send control signals that enable the DMA unit 608 to store the decoded 8×8 pixel block 214 in the main memory 306. The top-level control state machine 602 may subsequently send status information to the CPU 502 to indicate that at least a portion of the encoded data associated with an image has been decoded and/or stored in the main memory 306.

The ability of the JPEG accelerator 504, for example, to perform transformation and/or quantization operations on a subsequent 8×8 block in the DCT/IDCT block 610 while the entropy coding module 616 performs RLC, entropy encoding, and/or bit packing operations on a transformed current 8×8 block may be referred to as pipelined processing. The ability of the JPEG accelerator 504, for example, to perform bit unpacking, entropy decoding and/or RLDC on a subsequent encoded bit stream in the entropy coding module 616 while the DCT/IDCT block 610 performs IDCT and/or inverse quantization operations on a decoded current encoded bit stream may also be referred to as pipelined processing.

The programmable breakpoint unit 604 may comprise suitable logic, circuitry, and/or code that may be utilized to generate an indication that the JPEG accelerator 504 has completed transformation and encoding processing of an 8×8 pixel block 100. Transformation processing may comprise DCT and/or quantization. Encoding processing may comprise RLC, entropy encoding, and/or bit packing. The programmable breakpoint unit 604 may also be utilized to generate an indication that the JPEG accelerator 504 has completed decoding and inverse transformation processing of an 8×8 pixel block 214. Decoding processing may comprise bit unpacking, entropy decoding and/or RLDC. Inverse transformation processing may comprise inverse quantization and/or IDCT.

The row/column counter block 606 may comprise suitable logic, circuitry, and/or code that may be utilized to a current row and/or current location associated with a pixel in an 8×8 pixel block 100 and/or 8×8 pixel block 214. For the encoding operation, the row/column counter block 606 may indicate a current row and/or column location associated with an 8×8 pixel block 100 in a picture or a video frame. For the decoding operation, the row/column counter block 606 may indicate a current row and/or column location associated with an 8×8 pixel block 214 in a picture or a video frame.

The DMA unit 608 may comprise suitable logic, circuitry, and/or code that may enable retrieval and/or storing of a block of data from/to the main memory 306, respectively. The DMA unit 608 may receive control signals from the top-level control state machine 602 that enables a block of data to be retrieved and/or stored from/to the main memory 306, respectively. The DMA unit 608 may retrieve and/or store a block of data from/to the main memory 306 via a system bus. The DMA unit 608 may receive control signals from the top level control state machine that enable a block of data to be retrieved and/or stored from/to the DCT/IDCT block 610. The DMA unit 608 may send status information to the top-level control state machine 602 that indicates when a block of data has been retrieved and/or stored from/to the main memory 306. The DMA unit 608 may send status information to the top-level control state machine 602 that indicates when a block of data has been retrieved and/or stored from/to the DCT/IDCT block 610.

The DCT/IDCT block 610 may comprise suitable logic, circuitry, and/or code that may enable DCT, IDCT, quantization, and/or inverse quantization on received data. The operation of the DCT/IDCT block 610 may be controlled by the HW/SW sharable control I/F 612, via a programmable interface. The DCT/IDCT module 614 may perform DCT, IDCT, quantization, and/or inverse quantization processing. The DCT/IDCT module 614 may receive control signals and/or data from the HW/SW sharable control I/F 612.

The HW/SW sharable control I/F 612 may comprise suitable logic, circuitry, and/or code that may enable operation of the DCT/IDCT module 614. The HW/SW sharable control I/F 612 may receive control signals from the top-level control state machine 602 and/or from the CPU 502. The HW/SW sharable control I/F 612 may also send status information to the top-level control state machine 602 and/or to the CPU 502. The received control signals may enable the HW/SW sharable control I/F 612 to receive and/or send an 8×8 block of data. The received control signals may also enable the HW/SW sharable control I/F 612 to receive and/or send a bit stream. The received control signals may also enable the HW/SW sharable control I/F 612 to send control signals and/or data to the DCT/IDCT module 614.

For the encoding operation the HW/SW sharable control I/F 612 may send an 8×8 block of data to the DCT/IDCT module 614 for transformation processing. At the completion of transformation processing on the 8×8 block of data, the HW/SW sharable control I/F 612 may receive a corresponding transformed block of data from the DCT/IDCT module 614. For the decoding operation the HW/SW sharable control I/F 612 may send an 8×8 block of data to the DCT/IDCT module 614for inverse transformation processing. At the completion of inverse transformation processing on the 8×8 block of data, the HW/SW sharable control I/F 612 may receive a corresponding inverse transformed block of data from the DCT/IDCT module 614.

The entropy coding module 616 may comprise suitable logic, circuitry, and/or code that may enable RLC, RLDC, entropy encoding, entropy decoding, bit packing, and/or bit unpacking operation on received data. The RLC block 108, entropy encoding block 110, the bit packer block 112, the bit unpacker block 202, the entropy decoding block 204, and the RLDC block 206 may each receive control signals from the top-level control state machine 602. The control signals the RLC block 108, entropy encoding block 110, bit packer block 112, bit unpacker block 202, entropy decoding block 204, and/or RLDC block 206 to perform their respective function on received data. The RLC block 108, entropy encoding block 110, the bit packer block 112, the bit unpacker block 202, the entropy decoding block 204, and the RLDC block 206 may also send status information to the top-level control state machine 602.

The ability of the RLC block 108 to perform RLC operations on a subsequent bit stream while the entropy encoding block 110 performs entropy encoding operations on an RLC current bit stream may be referred to as pipelined processing. The ability of the bit packing block 112 to insert stuff bits into an entropy encoded current bit stream while the entropy encoding block 110 performs entropy encoding operations on an RLC subsequent bit stream may also be referred to as pipelined processing.

The ability of the bit unpacking block 202 to remove stuff bits from a subsequent encoded bit stream while the entropy decoding block 204 performs entropy decoding operations on an unstuffed current encoded bit stream may be referred to as pipelined processing. The ability of the entropy decoding block 204 to perform entropy decoding on an unstuffed subsequent encoded bit stream while the RLDC block 206 performs RLDC operations on an entropy decoded current encoded bit stream may also be referred to as pipelined processing.

In operation, the CPU 502 may send control signals to the top level state machine 702 via the software control I/F. The control signals may instruct the JPEG accelerator 504 to encode an image stored in the main memory 306. The row/column counter 706 may comprise information indicating what portion of the selected 8×8 block has been transformed by the DCT/IDCT block 610. The row/column counter 706 may also comprise information indicating what portion of the transformed selected 8×8 block has currently been encoded by the entropy coding module 616. Status information from the programmable breakpoint unit 604 and/or the row/column counter 706 may be utilized by the top-level control state machine 602 to generate control signals and/or status information.

The top-level control state machine 602 may select an 8×8 pixel block 100 from the stored image. The top-level control state machine 602 may configure the programmable breakpoint unit 604 to generate status information to indicate when the DCT/IDCT block 610 has completed transform operations on the selected 8×8 pixel block 100. The programmable breakpoint unit may also be configured to generate status information to indicate when the entropy coding module 616 has completed encoding operations on a transformed selected 8×8 block.

For the encoding operation, the top-level control state machine 602 may generate control signals that enable the DMA unit 608 to transfer data from the selected 8×8 pixel block 100 from the main memory 306, to the HW/SW sharable control I/F block 612. The HW/SW sharable control I/F block 612 may enable the DCT/IDCT module 614 to perform DCT and quantization operations on the selected 8×8 pixel block 100. The transformed selected 8×8 block may be stored in the HW/SW sharable control I/F block 612. The top-level control state machine 602 may generate control signals that enable the DCT/IDCT block 610 to transfer at least a portion of the transformed selected 8×8 block to the RLC block 108. The top-level control state machine 602 may generate control signals that enable the RLC block 108, encoding block 110, and/or the bit packer block 112 to perform encoding operations on the transformed selected 8×8 block. Upon completion of encoding operations on the transformed selected 8×8 block, the programmable breakpoint unit 604 may send status information to the top-level control state machine 602. The top-level control state machine 602 may send control signals that enable the DMA unit 608 to transfer an encoded bit stream from the bit packer block 112 to the main memory 306. The top-level control state machine 602 may send status information to the CPU 502.

For the decoding operation, the top-level control state machine 602 may generate control signals that enable the DMA unit 608 to transfer encoded data from the main memory 306, to the bit unpacker block 202. The top-level control state machine 602 may generate control signals that enable the bit unpacker block 202, the entropy decoding block 204, and/or the RLDC block 206 to perform decoding operations on the transferred encoded data. Upon completion of decoding operations on the transferred encoded data, the top-level control state machine 602 may generate control signals that enable the Entropy Coding module 616 to transfer at least a portion of a decoded bit stream to the HW/SW sharable control I/F block 612.

The HW/SW sharable control I/F block 612 may enable the DCT/IDCT module 614 to perform IDCT and inverse quantization operations on the decoded bit stream. An inverse transformed 8×8 block may be stored as a decoded 8×8 pixel block 214 in the HW/SW sharable control I/F block 612. The top-level control state machine 602 may generate control signals that enable the DMA unit 608 to transfer the decoded 8×8 pixel block 214 from the HW/SW sharable control I/F block 612 to the main memory 306.

Upon completion of inverse transformation operations on the decoded 8×8 pixel block 214, the programmable breakpoint unit 604 may send status information to the top-level control state machine 602. The top-level control state machine 602 may send control signals that enable the DMA unit 608 to transfer the decoded 8×8 pixel block 214 from the HW/SW sharable control I/F block 612 to the main memory 306. The top-level control state machine 602 may send status information to the CPU 502.

The software control I/F may enable the CPU 502 to provide control signals to the HW/SW sharable control I/F 612. By utilizing this interface, the DCT/IDCT block 610 may perform operations under software control. For example, utilizing the software control I/F to the HW/SW sharable control I/F 612 may enable the DCT/IDCT block 610 to perform DCT acceleration for an Audio application running on CPU 502.

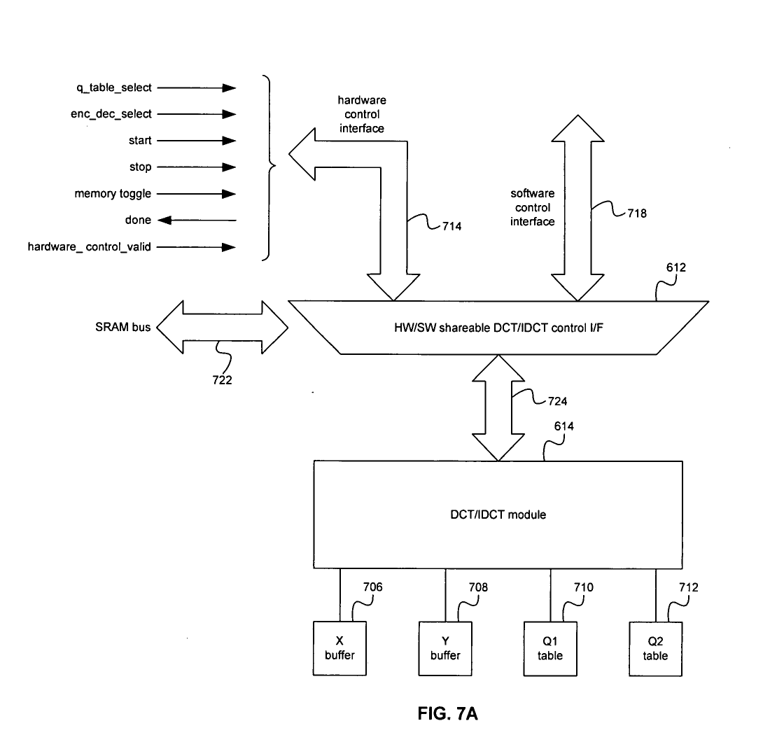

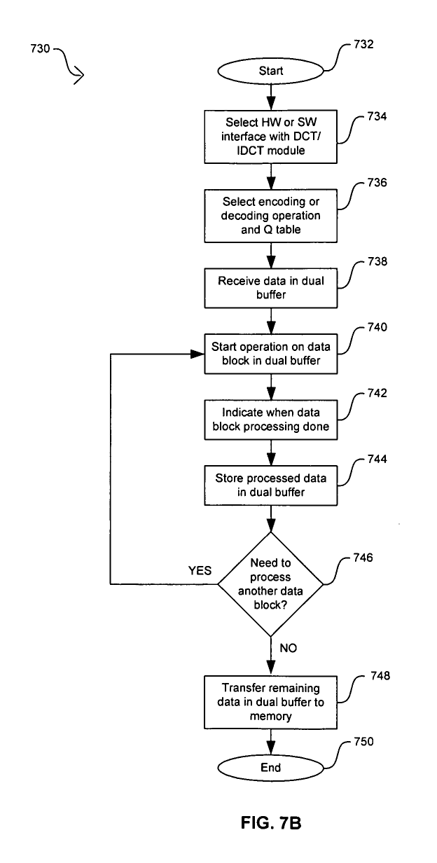

FIG. 7A is a block diagram illustrating an exemplary hardware/software (HW/SW) shareable interface for controlling a DCT/IDCT module, in accordance with an embodiment of the invention. Referring to FIG. 7A, there is shown a portion of the DCT/IDCT block 610 in FIG. 6 comprising the HW/SW shareable DCT/IDCT control I/F 612 and the DCT/IDCT module 614. The HW/SW shareable DCT/IDCT control I/F 612 and the DCT/IDCT module 614 may communicate via a single interface 724. An X buffer 706 and a Y buffer 708 are also shown. The X buffer 706 and a Y buffer 708 each may comprise suitable logic, circuitry, and/or code that may enable pipeline processing of data communicated to and from the DCT/IDCT module 614. The X buffer 706 and the Y buffer 708 may each be implemented as a portion of a dual buffer, for example. A Q1 table 710 and a Q2 table 712 are also shown. The Q1 table 710 and a Q2 table 712 each may comprise suitable logic, circuitry, and/or code that may enable storing and accessing tables comprising quantization coefficients that may be utilized for quantizing luma (Y) and chroma (Cr) pixel information respectively. Each of the X buffer 706, the Y buffer 708, the Q1 table 710, and the Q2 table 712 may be integrated into the DCT/IDCT module 614.

The HW/SW shareable DCT/IDCT control I/F 612 may enable communication between the DCT/IDCT module 614 and the top-level control state machine 602 in FIG. 6 via the hardware control interface 714. In this regard, the top-level control state machine 602 may communicate control information to the DCT/IDCT module 614 to operate in accordance with the functions being performed by a JPEG accelerator, for example. The DCT/IDCT module 614 may communicate data processing status indications to the top-level control state machine 602 via the hardware control interface 714. The hardware control interface 714 may comprise at least one signal that may be utilized by the top-level control state machine 602 and by the DCT/IDCT module 614 to communicate control and/or status information.

The hardware control interface 714 may comprise an input signal to the HW/SW shareable DCT/IDCT control I/F 612, such as a hardware_control_valid signal, for example, for enabling communication between the DCT/IDCT module 614 and a JPEG accelerator. In an exemplary embodiment of the invention, when the hardware_control_valid signal is asserted, the top-level control state machine 602 may control the operations of the DCT/IDCT module 614 while the JPEG accelerator, such as the JPEG accelerator 504 in FIGS. 5A-5B, for example, may communicate data with the DCT/IDCT module 614 via the SRAM bus 722. The SRAM bus 722 may be communicatively coupled to the DMA unit 608 in FIG. 6, for example. The SRAM bus 722 may be implemented as part of the hardware control interface 714, for example. When the hardware_control_valid signal is deasserted, a processor, such as the CPU 502 in FIGS. 5A-5B, for example, may utilize a software control interface 718 to control the DCT/IDCT module 614 via the HW/SW shareable DCT/IDCT control I/F 612. In this regard, the processor may also communicate data with the DCT/IDCT module 614 via the SRAM bus 722.

The hardware control interface 714 may also comprise an input signal, such as an enc_dec_select signal, for example, to the HW/SW shareable DCT/IDCT control I/F 612 for selecting between encoding and decoding operations in the DCT/IDCT module 614. In this regard, the enc_dec_select signal may specify whether the DCT/IDCT module 614 operates in a DCT or encoding mode, or in an IDCT or decoding mode. The hardware control interface 714 may also comprise an input signal to HW/SW shareable DCT/IDCT control I/F 612, such as a q_table_select signal, for example, for selecting between using the quantization coefficients stores in the Q1 table 710 or in the Q2 table 712 in the DCT/IDCT module 614. The appropriate selection may be based on whether the current data being processed is luma or chroma pixel information. The hardware control interface 714 may also comprise an input signal to the HW/SW shareable DCT/IDCT control I/F 612, such as a X-Y_memory_toggle signal, for example, which may be utilized for toggling or switching between the X buffer 706 and the Y buffer 708 when communicating data to and from the DCT/IDCT module 614.

The hardware control interface 714 may also comprise an input signal to the HW/SW shareable DCT/IDCT control I/F 612, such as a start signal, for example, to initiate data processing in the DCT/IDCT module 614. Asserting the start signal may initiate processing of one data block or macroblock. Each additional data block or macroblock to be processed by the DCT/IDCT module 614 may require additional assertions of the start signal. The hardware control interface 714 may also comprise an input signal to the HW/SW shareable DCT/IDCT control I/F 612, such as a stop signal, for example, to terminate data processing in the DCT/IDCT module 614. The stop signal may be utilized for debugging operations or for halting the operation of the DCT/IDCT module 614 when an error is detected, for example. The hardware control interface 714 may also comprise an output signal to the top-level control state machine 602 from the HW/SW shareable DCT/IDCT control I/F 612, such as a done signal, for example, which may indicate when processing on a data block or macroblock has been completed by the DCT/IDCT module 614.

In a hardware control mode of operation, for example, the data communicated with the X buffer 706, the Y buffer 708, the Q1 table 710, and/or the Q2 table 712 may be written and/or read by the DMA unit 608 through the SRAM bus 722. In this regard, the SRAM bus 722 may comprise control registers and/or a data bus to the X buffer 706, the Y buffer 708, the Q1 table 710, and/or the Q2 table 712.

The HW/SW shareable DCT/IDCT control I/F 612 may also enable communication between the DCT/IDCT module 614 and a processor, such as the CPU 502 in FIGS. 5A-5B, for example, via a software control interface 718. The processor may be utilized to execute audio applications, video applications, and/or other type of multimedia applications that may utilize the DCT/IDCT module 614 for signal processing operations. For example, the processor may be utilized for video encoding and video decoding operations for MPEG and/or H.263 applications. In this regard, the processor may communicate control information to the DCT/IDCT module 614 to operate in accordance with the functions being performed by at least one multimedia application being executed in the processor, for example. The processor and the DCT/IDCT module 614 may communicate data via the software control interface 718, for example. In a software control mode of operation, for example, the data communicated with the X buffer 706, the Y buffer 708, the Q1 table 710, and/or the Q2 table 712 may be written and/or read by a processor, such as the CPU 502, through the software control interface 718. In this regard, the software control interface 718 may comprise control registers and/or a data bus to the X buffer 706, the Y buffer 708, the Q1 table 710, and/or the Q2 table 712.

The DCT/IDCT module 614 may communicate data processing status indications to the processor via the software control interface 718. The software control interface 718 may correspond to at least one signal that may be utilized by the processor and by the DCT/IDCT module 614 to communicate control and/or status information. In this regard, de-asserting the hardware_control_valid signal, for example, may enable the processor and the DCT/IDCT module 614 to communicate control and/or status information. The software control interface 718 may be implemented via a bus, such as a slave bus, for example. The signals that correspond to the software control interface 718 and the signals that correspond to the hardware control interface 714 may have equivalent register bits in the HW/SW shareable DCT/IDCT control I/F 612.

In operation, asserting the hardware_control_valid signal in the HW/SW shareable DCT/IDCT control I/F 612 enables the top-level control state machine 602 to control the DCT/IDCT module 614. The JPEG accelerator 504 may transfer data to the DCT/IDCT module 614 via the DMA unit 608 and the SRAM bus 722. The top-level control state machine 602 may control the mode of operation, the Q table selection, the input and output of data, and the data block processing in the DCT/IDCT module 614 in accordance with the functions being performed by the JPEG accelerator 504. The DCT/IDCT module 614 may indicate to the top-level control state machine 602 the completion of processing of each data block. The JPEG accelerator 504 may receive the processed data via the SRAM bus 722 and the DMA unit 608.

When the hardware_control_valid signal is de-asserted, the HW/SW shareable DCT/IDCT control I/F 612 enables a processor, such as the CPU 502, to control of the DCT/IDCT module 614. A multimedia application being executed in the processor may transfer data to the DCT/IDCT module 614 via the software control interface 718. The multimedia application may control the mode of operation, the Q table selection, the input and output of data, and the data block processing in the DCT/IDCT module 614. The DCT/IDCT module 614 may indicate to the multimedia application the completion of processing of each data block. The multimedia application may receive the processed data via the software control interface 718.

FIG. 7B is a flow diagram illustrating exemplary steps in the operation of the hardware/software shareable interface, in accordance with an embodiment of the invention. Referring to FIG. 7B, there is shown a flow chart 730 that corresponds to an exemplary operation of the HW/SW shareable DCT/IDCT control I/F 612. In step 734, after start step 732, the hardware_control_valid signal may be utilized to select between control of the DCT/IDCT module via the hardware control interface 714 or via the software control interface 718. The hardware_control_valid signal may be generated by the top-level control state machine 602, for example. In some instances, the hardware_control_valid signal may be generated by the top-level control state machine 602 in accordance with instructions from a processor, such as the CPU 502 in FIGS. 5A-5B. In step 736, an encoding or decoding mode of operation is selected. For each data block or macroblock, one of the Q1 table 710 and the Q2 table 712 may be selected in accordance to whether the information in the block or macroblock being processed is luma or chroma pixel information, for example.

In step 738, one of the X buffer 706 and the Y buffer 708 may receive data for processing via the SRAM bus 722 in hardware control mode or via the software control interface 718 in software control mode. The dual buffer operation provided by the X buffer 706 and the Y buffer 708 enables pipelining data in and out of the DCT/IDCT module 614. In step 740, a start signal may be received to encode or decode the first data block in the dual buffer. In step 742, the DCT/IDCY module 614 may generate a signal to indicate that processing in the current data block has been completed. In step 744, the processed data block may be stored in the dual buffer for later retrieval via the SRAM bus 722 in hardware control mode or via the software control interface 718 in software control mode, for example. In step 746, when there are additional data blocks to be processed in the dual buffer, the process may proceed back to step 740 where a new start signal is generated to process the next data block. When no additional data blocks remain for processing by the DCT/IDCT module 614, the process may proceed to step 748. In step 748, any remaining processed data blocks in the dual buffer may be transferred out of the DCT/IDCT module 614 via the SRAM bus 722 in hardware control mode or via the software control interface 718 in software control mode, for example.

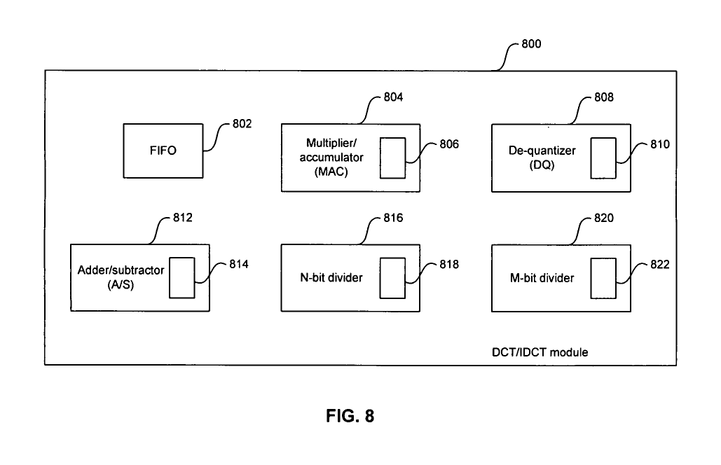

FIG. 8 is a block diagram of exemplary processing elements in a DCT/IDCT module, in accordance with an embodiment of the invention. Referring to FIG. 8, the DCT/IDCT module 800 is a configurable module that may enable encoding and decoding operations for a plurality of multimedia applications. The DCT/IDCT module 800 may correspond to the DCT/IDCT module 614, for example, and may be controlled, at least in part, via the hardware control interface 714 or the software control interface 718. In this regard, the DCT/IDCT module 800 may comprise a FIFO 802, a multiplier/accumulator (MAC) 804, a bit-width reduction (BWR) block 806, a de-quantizer (DQ) 808, a BWR block 810, an adder/subtractor (A/S) 812, a BWR block 814, an N-bit divider 816, a BWR block 818, an M-bit divider 820, and a BWR block 822. The operation and configuration of these processing elements may be modified.

The FIFO 802 may comprise logic, circuitry, and/or code that may enable buffering and ordering of data. In an exemplary embodiment of the invention, the FIFO 802 may be implemented in, for example, an 8-bit circular FIFO configuration. The FIFO 802 may receive video data input from the MAC 804 or from the memory, for example. The output of the FIFO 802 may be, for example, a 16-bit wide output.

The A/S 812 may comprise logic, circuitry, and/or code that may enable performing digital addition or digital subtraction. The A/S 812 may receive data from the MAC 804 or from the output of the FIFO 802. The MAC 804 may generate an output when the DCT/IDCT module 800 is encoding data. The MAC 804 may also generate an output when the DCT/IDCT module 800 is decoding data. At least one of these outputs generated from the MAC 804 may be provided as an input to the A/S 812. The output of the A/S 812 may be, for example, a 16-bit wide output. The A/S 812 may comprise a BWR block 814. The BWR block 814 may comprise suitable logic, circuitry, and/or code that may enable converting the result from the digital addition or from the digital subtraction to at least one of a plurality of bit-width number representations. In one embodiment of the invention, the BWR block 814 may be implemented as a hardware resource that may be part of the A/S 812. In another embodiment of the invention, the BWR block 814 may be implemented as a hardware resource that may be separate from the A/S 812, but may be coupled to the A/S 812.

The MAC 804 may comprise suitable logic, circuitry, and/or code that may enable performing digital multiplication and accumulation. The MAC 804 may receive data from the output of the de-quantizer 808, from the output of the A/S 812, and/or from a plurality of multiplicands that may be stored in memory, for example. The output of the MAC 804 may be, for example, a 12-bit wide output. The MAC 804 may comprise a BWR block 806. The BWR block 806 may suitable comprise logic, circuitry, and/or code that may enable converting the result from the digital multiplication and accumulation to an n-bit wide number, where n≧1. The BWR block 806 may be implemented as a hardware resource that is part of the MAC 804 or it may be implemented as a hardware resource that is separate but coupled to the MAC 804.

The DQ 808 may comprise logic, circuitry, and/or code that may enable de-quantization of data blocks or macroblocks. The DQ 808 may receive data from memory, and/or from an encoding processing element, such as a quantizer, for example. The output of the DQ 808 may be, for example, a 16-bit wide output. The DQ 808 may comprise a BWR block 810. The BWR block 810 may comprise logic, circuitry, and/or code that may enable converting the result from the de-quantization to an n-bit wide number, where n≧1. In an exemplary embodiment of the invention, n may be equal to 8, 9, 10, or 11 bits and the number may be in signed or unsigned representation. The BWR block 810 may be implemented as a hardware resource that is part of the DQ 808 or it may be implemented as a hardware resource that is separate but coupled to the DQ 808.

The M-bit divider 820 may comprise logic, circuitry, and/or code that may enable M-bit digital division. For example, the M-bit divider 820 may be implemented to perform 12-bit digital division. The M-bit divider 820 may receive video data from the MAC 804. The output of the M-bit divider 820 may be, for example, an 8-bit wide output. The M-bit divider 820 may comprise a BWR block 822. The BWR block 822 may comprise logic, circuitry, and/or code that may enable converting the result from the M-bit division into at least one of a plurality of bit-width number representations. For example, the bit-width may be 7, 8, 9, or 10 bits and the number may be in signed or unsigned representation.

The N-bit divider 816 may comprise logic, circuitry, and/or code that may enable N-bit digital division. For example, the N-bit divider 816 may be implemented to perform 7-bit digital division. The N-bit divider 816 may receive video data from the M-bit divider 820. The output of the N-bit divider 816 may be, for example, a 9-bit wide output. The N-bit divider 816 may comprise a BWR block 818. The BWR block 818 may comprise suitable logic, circuitry, and/or code and may convert the result from the N-bit division to an n-bit wide number, where n≧1. In one exemplary embodiment of the invention, n may be equal to 7, 8, 9, or 10 bits and the number may be in signed or unsigned representation. In one embodiment of the invention, the BWR block 818 may be implemented as a hardware resource that may be part of the N-bit divider 816. In one exemplary embodiment of the invention, the BWR block 818 may implemented as a hardware resource that may be separate from the N-bit divider 816, but may be coupled to the N-bit divider 816.

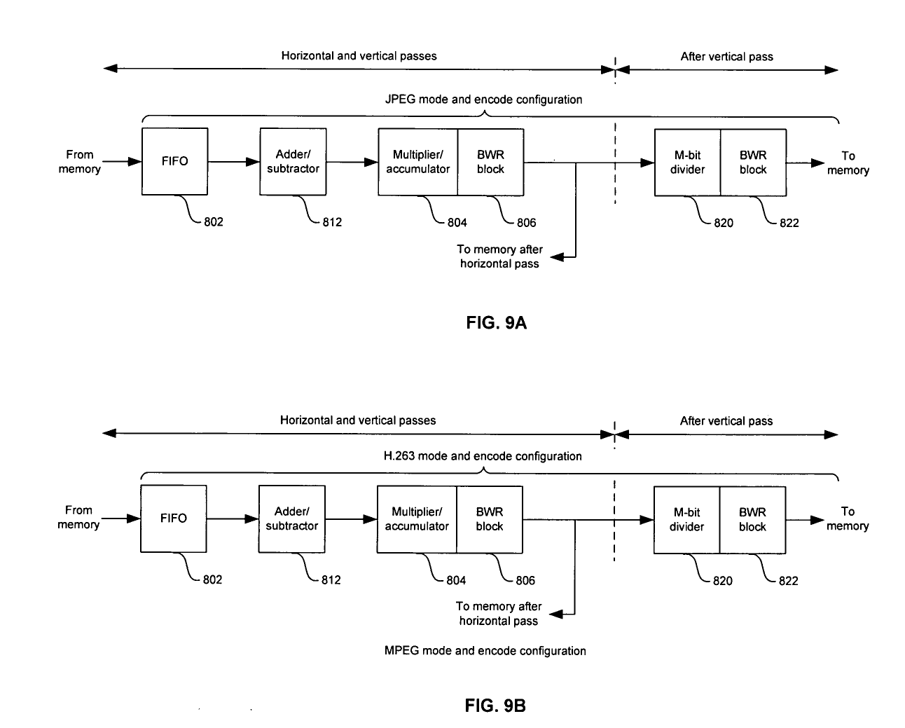

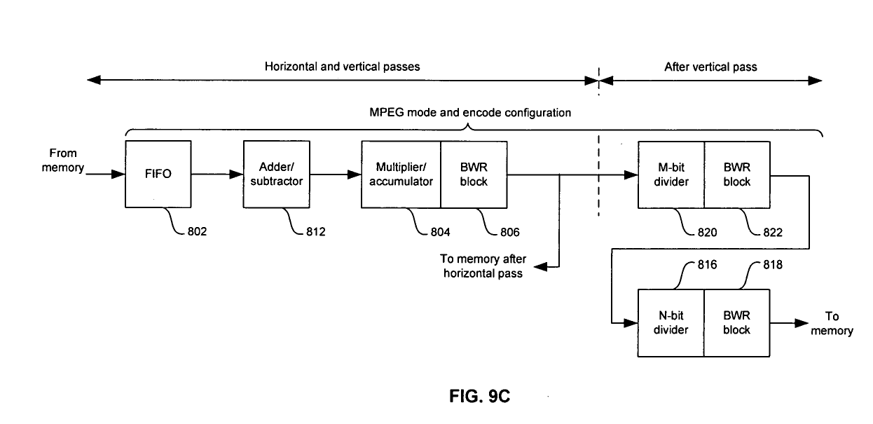

FIGS. 9A-9C illustrate exemplary DCT processing network configurations for JPEG, MPEG, and H.263 video formats, in connection with an embodiment of the invention. Referring to FIG. 9A, the JPEG encoding operation may be implemented by configuring the DCT/IDCT module 800 in a DCT processing network configuration that may comprise the FIFO 802, the A/S 812, the MAC 804, the BWR block 806, the M-bit divider 820, and the BWR block 822. The FIFO 802 may be implemented as an 8-bit circular FIFO. The M-bit divider 820 may be implemented as a 12-bit divider. The BWR block 806 may be configured to provide output rounding and the BWR block 822 may be configured to provide output rounding and clipping. Horizontal and vertical passes may refer to the multiplication and addition functions carried out on rows and columns when determining the encoded data block or macroblock.

Referring to FIG. 9B, the H.263 encoding operation may be implemented by configuring the DCT/IDCT module 800 in a DCT processing network configuration that may comprise the FIFO 802, the A/S 812, the MAC 804, the BWR block 806, the M-bit divider 820, and the BWR block 822. In an exemplary embodiment of the invention, the FIFO 802 may be implemented as an 8-bit circular FIFO. The M-bit divider 820 may be implemented as a 12-bit divider. The BWR block 806 may be configured to provide output rounding and the BWR block 822 may be configured to provide output rounding and clipping.

Referring to FIG. 9C, the MPEG4 encoding operation may be implemented by configuring the DCT/IDCT module 800 in a DCT processing network configuration that may comprise the FIFO 802, the A/S 812, the MAC 804, the BWR block 806, the M-bit divider 820, the BWR block 822, the N-bit divider 816, and the BWR block 818. The M-bit divider 820 may be implemented as a 12-bit divider and the N-bit divider may be implemented as a 7-bit divider. In an exemplary embodiment of the invention, the FIFO 802 may be implemented as an 8-bit circular FIFO. The BWR 306 may be configured to provide output rounding and the BWR block 822 and the BWR block 818 may be configured to provide output rounding and clipping.

A processor, such as the CPU 502 in FIGS. 5A-5B, for example, may be utilized to configure the DCT network processing configurations shown in FIGS. 9A-9C by configuring the inputs, outputs and/or data processing in at least one of the plurality of processing elements in the DCT/IDCT module 800. Moreover, the configuration of the DCT/IDCT module 800 may be based on, for example, the hardware_control_valid signal.

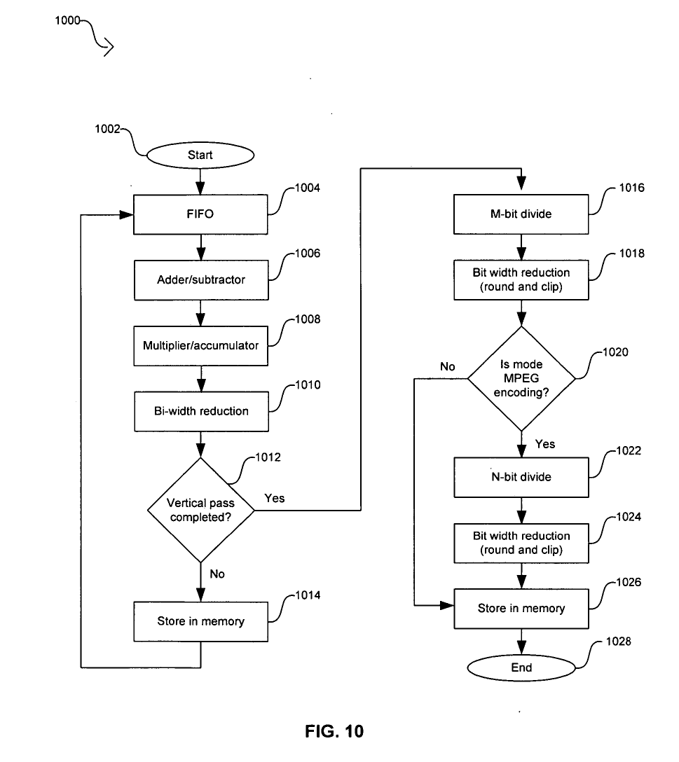

FIG. 10 is a flow chart illustrating exemplary steps for the encoding of video signals utilizing the DCT/IDCT module in a DCT processing network configuration, in accordance with an embodiment of the invention. Referring to FIG. 10, in the encoding operation 1000, after start step 1002, the data blocks and/or macroblocks may be received by the FIFO 802 from memory in step 1004. In step 1006, the A/S 812 may add or subtract the appropriate parameters to perform the encoding function depending on the video format mode of operation. In step 1008, the MAC 804 may perform the multiplications and accumulations necessary. In step 1010, the BWR block 806 may provide bit-width reduction by rounding the output of the MAC 804. In step 1012, the encoding operation 1000 may determine whether the current vertical pass completed all vertical passes on the data block or macroblock. When the current pass is a horizontal pass, intermediate encoding values may be stored in memory in step 1014. When the current vertical pass is the last vertical pass, then the final values may be sent to the M-bit divider 820 for, for example, the 12-bit divide function in step 1016. When the current vertical pass is not the last vertical pass, then the encoding operation may return to step 1004 where video data information from memory may be sent to the FIFO 802.

In step 1018, the BWR 822 may provide bit-width reduction by rounding and clipping the output of the M-bit divider 820. In step 1020, the DCT/IDCT module 800 may determine whether the DCT network processing configuration provides encoding for MPEG4 matrix-based quantization scheme. When the DCT network processing configuration provides encoding for MPEG4 matrix-based quantization scheme, then the encoding operation 1000 may proceed to step 1022 where the N-bit divider 1016 may provide, for example, a 7-bit digital division. In step 1024, the BWR block 818 may provide bit-width reduction by rounding and clipping the results from step 1022. The bit-width reduced output from step 624 may be stored into memory in step 1026. Returning to step 1020, when the DCT network processing configuration provides encoding for JPEG or H.263 video formats, then the encoding operation 1000 may proceed to store the results of step 1018 into memory in step 1026. In step 1028, the encoding of the data block or macroblock is completed and the processing of a new data block or macroblock may be started.

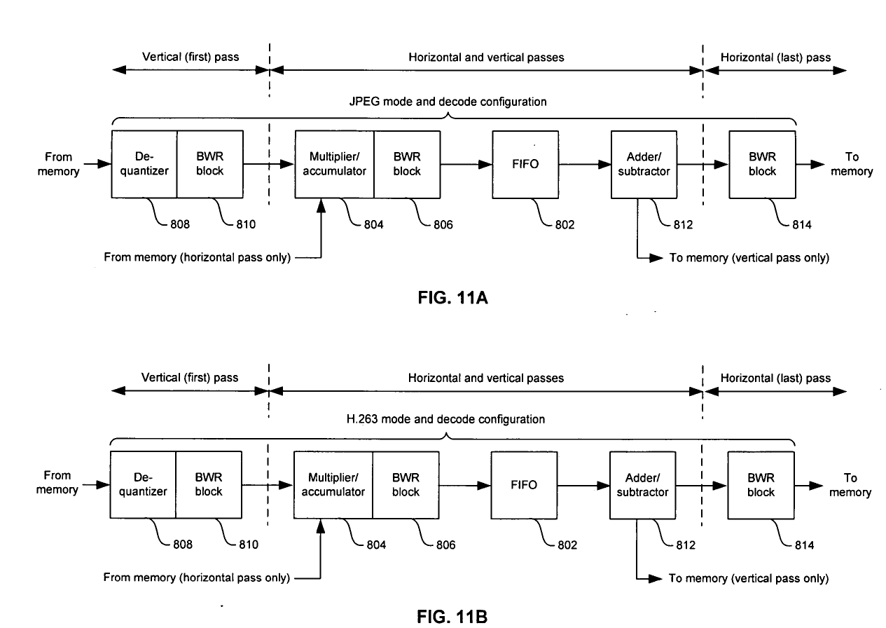

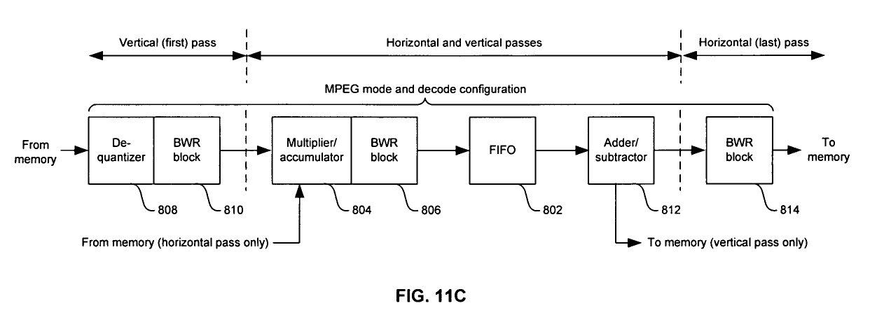

FIGS. 11A-11C illustrate exemplary IDCT processing network configurations for JPEG, MPEG, and H.263 video formats, in connection with an embodiment of the invention. Referring to FIGS. 11A-11C, the JPEG, H.263, and MPEG4 decoding operations may be implemented by configuring the DCT/IDCT module 800 in a DCT processing network configuration that may comprise the DQ 808, the BWR block 810, the MAC 804, the BWR block 806, the FIFO 802, the A/S 812, and the BWR block 814. In an exemplary embodiment of the invention, the FIFO 802 may be implemented as an 8-bit circular FIFO. The BWR block 810 may be configured to provide output clipping, while the BWR block 806 may be configured to provide output rounding and clipping. The BWR block 814 may also be configured to provide output rounding. The DQ 808 may be configured to provide multiplication in a JPEG video format mode of operation. The DQ 808 may be configured to provide multiplication and may utilize the quant_add parameter in an H.263 video format mode of operation. The DQ 808 may be configured to provide multiplication and sign format in an MPEG4 video format mode of operation.

The horizontal and vertical passes indicated in FIGS. 11A-11C may refer to the computations carried out on rows and columns of a macroblock when determining the decoded video data block or macroblock. The DQ 808 and the BWR block 810 may be utilized during the first vertical pass of decoding, while the MAC 804, BWR block 806, FIFO 802, and A/S 812 may be utilized during the following vertical passes and corresponding horizontal passes of decoding. The MAC 804 may receive intermediate results from memory during horizontal passes and the A/S 812 may transfer intermediate results to memory during vertical passes. The BWR block 814 may be utilized during the last horizontal pass of encoding before the final results are transferred to memory.

A processor, such as the CPU 502 in FIGS. 5A-5B, for example, may be utilized to configure the IDCT network processing configurations shown in FIGS. 11A-11C by configuring the inputs, outputs, and/or data processing in at least one of the plurality of processing elements in the DCT/IDCT module 800. Moreover, the configuration of the DCT/IDCT module 800 may be based on, for example, the hardware_control_valid signal.

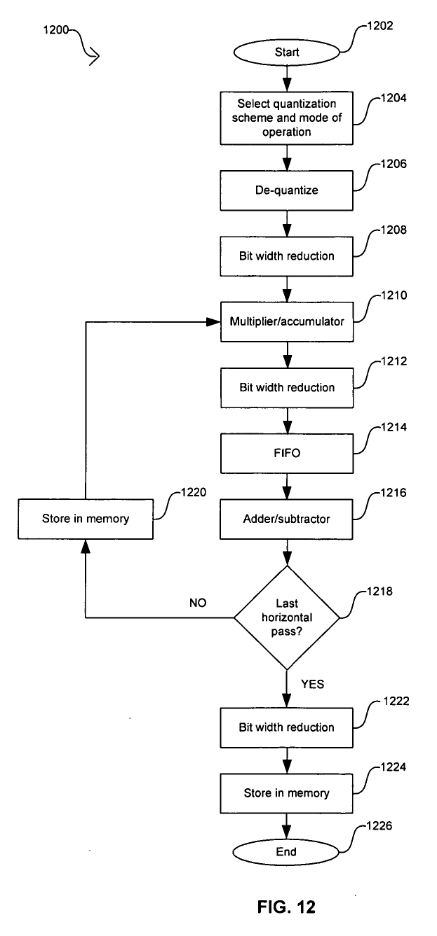

FIG. 12 is a flow chart illustrating exemplary steps for the decoding of video signals utilizing the DCT/IDCT module in a IDCT processing network configuration, in accordance with an embodiment of the invention. Referring to FIG. 12, in the encoding operation 1200, after start step 1202, the encoded data blocks or macroblocks may be received by the DQ 808 from memory and the quantization scheme and video format mode of operation may be determined in step 1204. The de-quantization operation 1206 may implement a JPEG quantization scheme, matrix-based MPEG4 quantization scheme, or H.263 quantization scheme as determined in step 1204. The DQ 808 and the BWR block 810 may be configured to operate in the appropriate quantization scheme and video format. In step 1208, bit width reduction may be performed in accordance with the quantization scheme and video format determined in step 1204. Step 1206 and step 1208 correspond to the first vertical pass on the encoded video data blocks.

In step 1210, the MAC 804 may be utilized to perform vertical or horizontal decoding computations. The width of the data, in bits, resulting from these computations may be reduced by the BWR block 806 in step 1212 in accordance with the quantization scheme and video format determined in step 1204. In step 1214, the output from the BWR block 806 may be stored in the FIFO 802. In step 1216, the A/S 812 may perform addition or subtraction computations on the output of the FIFO 802. Steps 1210 through step 1216 correspond to the vertical and horizontal passes on the encoded data blocks or macroblocks.

In step 1218, the decoding operation 1200 may determine whether the current horizontal pass completed all horizontal passes on the data block or macroblock. When the current horizontal pass is not the last pass, the intermediate results on vertical passes may be transferred to memory in step 1220. These results may be used by the MAC 804 in step 1210 for horizontal and vertical processing. When the current horizontal pass is the last pass of the decoding operation, the results of the A/S 812 may be bit-width reduced in step 822 by the BWR block 814 in accordance with the quantization scheme and video format determined in step 1204. The block BWR block 814 bypass mode may be disabled when configuring the DCT/IDCT module 800 in an IDCT processing network configuration. In step 1224, final results on horizontal passes may be transferred to memory. In step 1226, the decoding of the encoded video data block or macroblock is completed and the processing of a new encoded video data block or macroblock may be started.

The approach described herein may provide for coding and decoding operations for multimedia image and video applications in a relatively small area in a signal processing IC that is computationally efficient and operationally flexible.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for handling processing of image and video information, the method comprising:
selecting between a hardware operation and a software operation to control a discrete cosine transformation (DCT) and an inverse discrete cosine transformation (IDCT) via a single on-chip interface; and
controlling said DCT and IDCT via said single on-chip interface based on said selecting.

2. The method according to claim 1, further comprising selecting a quantization table for said DCT and IDCT via said single on-chip interface.

3. The method according to claim 1, further comprising toggling between a first and a second portion of a data buffer used for said DCT and IDCT.

4. The method according to claim 1, further comprising selecting one of an encoding operation and a decoding operation to be performed by said DCT and IDCT.

5. The method according to claim 1, further comprising starting processing of a data block by said DCT and IDCT via at least one control signal.

6. The method according to claim 1, further comprising communicating with a buffer associated with said DCT and IDCT via a data bus.

7. The method according to claim 1, further comprising indicating when said DCT and IDCT has completed processing a data block.

8. The method according to claim 1, further comprising controlling said hardware operation via a finite state machine.

9. A machine-readable storage having stored thereon, a computer program having at least one code section for handling processing of image and video information, the at least one code section being executable by a machine for causing the machine to perform steps comprising:
selecting between a hardware operation and a software operation to control a discrete cosine transformation (DCT) and an inverse discrete cosine transformation (IDCT) via a single on-chip interface; and
controlling said DCT and IDCT via said single on-chip interface based on said selecting.

10. The machine-readable storage according to claim 9, further comprising code for selecting a quantization table for said DCT and IDCT via said single on-chip interface.

11. The machine-readable storage according to claim 9, further comprising code for toggling between a first and a second portion of a data buffer used for said DCT and IDCT.

12. The machine-readable storage according to claim 9, further comprising code for selecting one of an encoding operation and a decoding operation to be performed by said DCT and IDCT.

13. The machine-readable storage according to claim 9, further comprising code for starting processing of a data block by said DCT and IDCT via at least one control signal.

14. The machine-readable storage according to claim 9, further comprising code for communicating with a buffer associated with said DCT and IDCT via a data bus.

15. The machine-readable storage according to claim 9, further comprising code for indicating when said DCT and IDCT has completed processing a data block.

16. The machine-readable storage according to claim 9, further comprising code for controlling said hardware operation via a finite state machine.

17. A system for handling processing of video and image information, the system comprising:
a discrete cosine transformation (DCT) and an inverse discrete cosine transformation (IDCT) block; and
a single on-chip interface that enables selecting between a hardware operation and a software operation to control said DCT and IDCT block.

18. The system according to claim 17, wherein said single on-chip interface enables selecting a quantization table for said DCT and IDCT.

19. The system according to claim 17, wherein said single on-chip interface enables toggling between a first and a second portion of a data buffer used for said DCT and IDCT.

20. The system according to claim 17, wherein said single on-chip interface enables selecting one of an encoding operation and a decoding operation to be performed by said DCT and IDCT.

21. The system according to claim 17, wherein said single on-chip interface enables starting processing of a data block by said DCT and IDCT via at least one control signal.

22. The system according to claim 17, wherein said single on-chip interface enables communicating with a buffer associated with said DCT and IDCT via a data bus.

23. The system according to claim 17, wherein said single on-chip interface enables indicating when said DCT and IDCT has completed processing a data block.

24. The system according to claim 17, further comprising a finite state machine for controlling said hardware operation.
